(19) United States
(12) Patent Application Publication
(10) Pub. No.: US 2024/0177533 A1
(43) Pub. Date: May 30, 2024

(54) SERVER

(71) Applicant: TOYOTA JIDOSHA KABUSHIKI KAISHA, Toyota-shi (JP)

(72) Inventors: Yuko TERASAWA, Tokyo-to (JP); Makoto KAKUCHI, Toyota-shi (JP); Toshiaki KARASAWA, Tokyo-to (JP); Takeshi HIGASHI, Nagoya-shi (JP); Yoshihiko ENDO, Tokyo-to (JP)

(73) Assignee: TOYOTA JIDOSHA KABUSHIKI KAISHA, Toyota-shi (JP)

(21) Appl. No.: 18/516,544

(22) Filed: Nov. 21, 2023

(30) Foreign Application Priority Data
Nov. 30, 2022 (JP) 2022-191460

(51) Int. Cl. G07C 5/00; B60L 53/66

(52) U.S. Cl. CPC G07C 5/008; B60L 53/665

(57) ABSTRACT

A server communicates with a vehicle that includes a battery. The server includes a communication device and a processing device. The communication device is configured to communicate with the vehicle. The processing device is configured to generate a restriction command for restricting discharge power of the battery. A first owner (user) as an owner of the vehicle has entered into a first lease contract for leasing the battery. When the owner has been changed from the first owner to a second owner and the second owner does not enter into a second lease contract for leasing the battery, the processing device transmits a restriction command to the vehicle through the communication device.

### CROSS REFERENCE TO RELATED APPLICATIONS

This nonprovisional application is based on Japanese Patent Application No. 2022-191460 filed on Nov. 30, 2022, with the Japan Patent Office, the entire contents of which are hereby incorporated by reference.

### BACKGROUND OF THE DISCLOSURE

### Field

The present disclosure relates to a server.

### Description of the Background Art

Japanese Patent Laying-Open No. 2002-269407 discloses a used car sales system.

### SUMMARY

Vehicles typically have power storage devices installed therein. Since power storage devices themselves are valuable, they are sometimes distributed separately from vehicles. In this case, an owner of a power storage device is, for example, a vehicle manufacturer, and is distinguished from an owner of a vehicle. An owner of a vehicle typically enters into a lease contract for a power storage device with an owner of the power storage device, and uses the power storage device. The owner of the power storage device manages the power storage device based on the lease contract. This owner may collect and reuse the power storage device after the lease contract has expired. Therefore, the lease contracts for power storage devices are preferable from the viewpoint of effective utilization of the power storage devices.

An owner of a vehicle may transfer a vehicle to another person (transferee) as a used vehicle while a power storage device is installed in the vehicle. If the vehicle is transferred without permission of the owner of the power storage device, the owner of the vehicle will be changed, but the owner of the power storage device may not be capable of identifying the transferee. As a result, the owner of the power storage device cannot enter into a lease contract with the transferee, and thus cannot manage the power storage device based on this lease contract. This is not preferable from the viewpoint of effective utilization of the power storage device.

The present disclosure has been made in view of the above-mentioned problems, and has an object to provide a server that enables effective utilization of a power storage device installed in a vehicle based on a lease contract for the power storage device.

A server of the present disclosure communicates with a vehicle including a power storage device. The server includes a communication device and a processing device. The communication device is configured to communicate with the vehicle. The processing device is configured to generate a restriction command for restricting discharge power of the power storage device. A first owner as an owner of the vehicle has entered into a first lease contract for leasing the power storage device. When the owner is changed from the first owner to a second owner, but the second owner does not enter into a second lease contract for leasing the power storage device, the processing device transmits a restriction command to the vehicle through the communication device.

With the above configuration, discharge power is restricted when the second owner has not entered into a lease contract. This causes inconvenience for the second owner due to the restriction of discharge power. As a result, the second owner can be motivated to enter into a lease contract in order to avoid such inconvenience. Therefore, the power storage device can be effectively used based on the lease contract for the power storage device.

Preferably, the communication device is configured to communicate with a first management server that stores registered owner information indicating a registered owner who is registered as an owner of the vehicle when a vehicle inspection of the vehicle is performed. The processing device acquires registered owner information from the first management server through the communication device, and determines according to the registered owner information whether or not the owner has been changed.

If a vehicle is transferred without permission of an owner of a power storage device, the owner of the power storage device may not be capable to identifying the transferee (an owner of the vehicle after the transfer). On the other hand, even after the vehicle has been transferred to the transferee, it is considered that vehicle inspection of the vehicle will be carried out periodically. The above configuration enables the server to determine based on the registered owner information who the current registered owner of the vehicle is, so that it is possible to determine that the owner of the vehicle has been changed from the first owner to the second owner.

Preferably, the communication device is configured to communicate with a second management server. The second management server stores payment status information indicating a payment status of a lease fee for the power storage device. The lease fee is set by the first lease contract as a fee that the first owner is required to pay for leasing the power storage device. The processing device acquires the payment status information from the second management server through the communication device, and acquires the registered owner information when the payment status information indicates non-payment of the lease fee over a predetermined threshold period of time.

If non-payment of the lease fee continues over a period longer than the threshold period, the first owner may have illegally transferred the vehicle to the second owner with the power storage device being installed in the vehicle. The above configuration allows the server to acquire payment status information when non-payment continues. As a result, the server can determine at an appropriate timing that the owner of the vehicle has been changed from the first owner to the second owner.

Preferably, the processing device acquires the registered owner information every predetermined period of time.

It is also considered preferable to periodically determine whether or not the owner of the vehicle has been changed. With the above configuration, the server acquires registered owner information every predetermined period of time, so that it can be periodically determined whether or not the owner of the vehicle has been changed.

Preferably, when determining that the owner has been changed to the second owner, the processing device transmits a first notification for prompting the second owner to enter into the second lease contract to the vehicle through the communication device.

The above configuration makes it possible to effectively motivate the second owner to enter into a second lease contract. As a result, power storage devices can be effectively used by a leasing company of the power storage devices.

Preferably, the processing device determines that the second owner does not enter into the second lease contract when receiving, through the communication device, a first disapproval signal indicating that the second owner does not enter into the second lease contract.

Preferably, the processing device transmits a cancel command for canceling a restriction of the discharge power to the vehicle through the communication device when the processing device receives, after receiving the first disapproval signal, a lease contract approval signal approving that the second owner enters into the second lease contract.

With the above configuration, restriction of discharge power is canceled, which eliminates the inconvenience for the second owner caused by the restriction of discharge power. As a result, the second owner can be effectively motivated to enter into a second lease contract.

Preferably, when determining that the second owner enters into the second lease contract, the processing device transmits, to the vehicle through the communication device, a second notification for prompting the second owner to enter into an insurance contract for the power storage device.

With the above configuration, the second owner can be motivated to enter into the insurance contract in addition to the lease contract. As a result, it is possible to avoid a situation in which the vehicle is not effectively used by the second owner after the failure of the power storage device.

Preferably, the processing device is configured to be capable of executing upper limit setting processing for setting an upper limit value of the discharge power. The upper limit setting processing includes first setting processing for setting the upper limit value to a first value when the second owner enters into the second lease contract and the second owner does not enter into an insurance contract for the power storage device, and second setting processing for setting the upper limit value to a second value higher than the first value when the second owner enters into the second lease contract and the second owner enters into the insurance contract.

When the upper limit value of the discharge power is set to a low value, there is a possibility that the power storage device is not sufficiently discharged and the convenience for a user of the vehicle is impaired. With the above configuration, when the second owner enters into both the second lease contract and the insurance contract, the upper limit value of the discharge power is set to a higher value as compared with a case where the second owner enters into only a second lease contract, and does not enter into any insurance contract. As a result, the power storage device can be sufficiently discharged, and the convenience for the user can be enhanced. As a result, the second owner can be motivated to enter into an insurance contract.

Preferably, the processing device determines that the second owner does not enter into the insurance contract when receiving, through the communication device, a second disapproval signal indicating that the second owner does not enter into the insurance contract.

Preferably, the processing device executes processing for providing an incentive to the first owner when receiving a transfer notification indicating that the first owner transfers the vehicle.

With the above configuration, the first owner can be motivated to notify the server of the transfer of the vehicle by the first owner, which enables the server to easily determine the transfer of the vehicle by the first owner. As a result, an operator of the server is easily determine the second owner, so that it is possible to increase a possibility of entering into a second lease contract with the second owner.

Preferably, the processing device executes processing for providing an incentive to the first owner when receiving a first cancel notification indicating that the first owner cancels the first lease contract.

With the above configuration, the first owner can be motivated to notify the server of the cancellation of the first lease contract, which enables the server to easily determine cancellation of the first lease contract. As a result, the operator of the server is easily determine the second owner, and thus it is easier to enter into a second lease contract with the second owner, which makes it possible to increase the possibility of entering into a second lease contract with the second owner.

According to another embodiment, another server is provided. This server communicates with a vehicle including a power storage device. The server includes a communication device and a processing device. The communication device is configured to communicate with the vehicle. The processing device is configured to generate a restriction command for restricting discharge power of the power storage device. A first owner as an owner of the vehicle has entered into a first insurance contract for the power storage device. The processing device transmits the restriction command to the vehicle through the communication device when the owner has been changed from the first owner to a second owner and the second owner does not enter into a second insurance contract for the power storage device.

The above configuration can motivate the second owner to enter into an insurance contract for the power storage device. As a result, it is possible to avoid a situation in which the vehicle is not effectively used by the second owner after failure of the power storage device.

Preferably, the processing device executes processing for providing an incentive to the first owner when receiving a second cancel notification indicating that the first owner cancels the first insurance contract.

The above configuration can motivate the first owner to notify the server of cancellation of the first insurance contract, which enables the server to easily determine cancellation of the first insurance contract. As a result, an operator of the server is easily determine the second owner, so that it is possible to increase the possibility of entering into a second insurance contract with the second owner. Therefore, it is possible to easily avoid a situation where the vehicle is not effectively used by the second owner after failure of the power storage device.

The foregoing and other objects, features, aspects and advantages of the present disclosure will become apparent from the following detailed description of the disclosure when taken in conjunction with the accompanying drawings.

### BRIEF DESCRIPTION OF THE DRAWINGS

FIG. 1 is a diagram illustrating a configuration of an information processing system in a first embodiment;

FIG. 2 is a diagram illustrating a data structure of a vehicle DB (Database);

FIG. 3 is a diagram illustrating a data structure of a contractor DB;

FIG. 4 is a diagram illustrating a data structure of a vehicle inspection information DB;

FIG. 5 is a diagram showing a problem caused in a case where a vehicle is transferred as a used car from a user U1 to another person;

FIG. 6 is a diagram showing features of a server;

FIG. 7 is a diagram illustrating a screen displayed on an HMI (Human Machine Interface) unit;

FIG. 8 is a diagram illustrating another screen displayed on the HMI unit;

FIG. 9 is a flowchart illustrating processing to be executed by the server according to the first embodiment;

FIG. 10 is a flowchart illustrating another processing to be executed by the server according to the first embodiment;

FIG. 11 is a diagram illustrating a data structure of an account information DB;

FIG. 12 is a flowchart illustrating processing to be executed by a server according to a first modification of the first embodiment;

FIG. 13 is a flowchart illustrating processing to be executed by a server according to a second modification;

FIG. 14 is a flowchart illustrating processing to be executed by a server according to a third modification;

FIG. 15 is a flowchart illustrating processing to be executed by a server according to a fourth modification;

FIG. 16 is a flowchart illustrating processing to be executed by a server according to a second embodiment; and

FIG. 17 is a flowchart illustrating processing executed by the server according to a modification of the second embodiment.

### DESCRIPTION OF THE PREFERRED EMBODIMENTS

Embodiments of the present disclosure will be described in detail hereunder with reference to the drawings. The same or corresponding portions in the figures are designated by the same reference signs, and description thereof will not be repeated. The respective embodiments and modifications thereof may be combined with one another as appropriate.

### First Embodiment

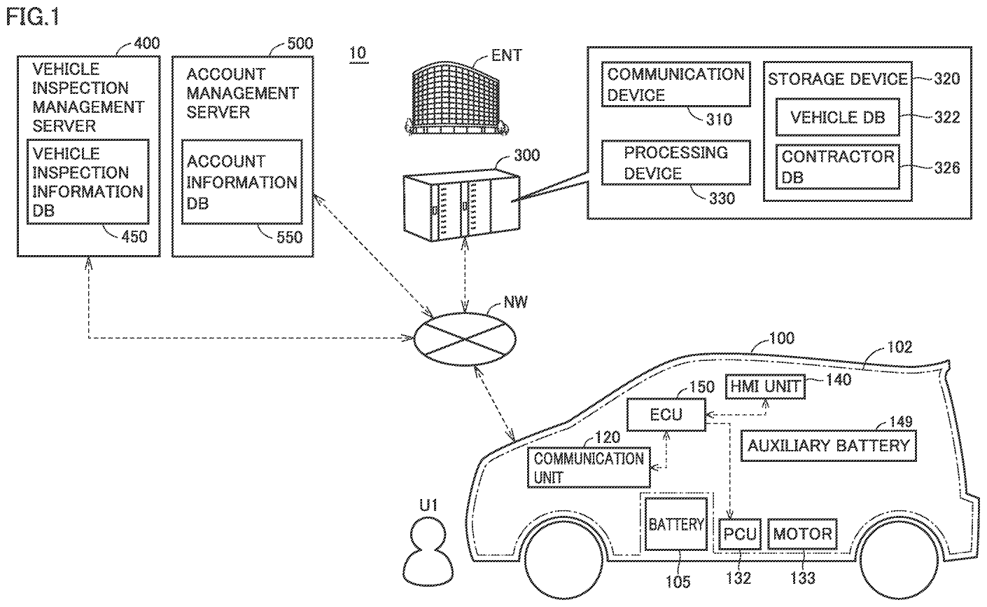

FIG. 1 is a diagram illustrating a configuration of an information processing system in a first embodiment. Referring to FIG. 1, an information processing system 10 includes a vehicle 100, a server 300, a vehicle inspection management server 400, and an account management server (bank server) 500.

Vehicle 100 is an electrically powered vehicle, and includes a base vehicle 102 and a battery 105. Base vehicle 102 is the remainder of vehicle 100 other than battery 105, and is owned by user U1.

Battery 105 stores electric power required traveling of vehicle 100. Battery 105 is an example of a “power storage device” of the present disclosure. The owner of battery 105 is an enterprise ENT, and is distinguished from the owner of base vehicle 102 (user U1). Enterprise ENT is a manufacturer of vehicle 100, and also a leasing company of battery 105.

User U1 has entered into a lease contract with enterprise ENT to lease battery 105 from enterprise ENT (this lease contract has been continued since the purchase of vehicle 100). In addition, user U1 has entered into an insurance contract for battery 105 with enterprise ENT (this insurance contract has been continued since the purchase of vehicle 100). This insurance contract is, for example, a contract for reducing a repair cost required to repair a damage when battery 105 suffers the damage while user U1 is using vehicle 100.

If no insurance contract has been made, user U1 may pay a large amount of repair cost when battery 105 is damaged. As a result, user U1 may lose motivation to use vehicle 100 (base vehicle 102) again. This is not preferable from the viewpoint of effective utilization of base vehicle 102. On the other hand, according to the insurance contract, when battery 105 is damaged, user U1 only has to pay a reduced repair cost. Therefore, it is possible to avoid a situation in which the owner of vehicle 100 (vehicle owner) loses motivation to use vehicle 100 due to damage to battery 105. As a result, it is possible to avoid a situation in which vehicle 100 is not effectively utilized after battery 105 is damaged.

Base vehicle 102 includes a communication unit 120, a PCU (Power Control Unit) 132, a motor 133, an HMI unit 140, an auxiliary battery 149, and an ECU (Electronic Control Unit) 150.

Communication unit 120 wirelessly communicates with server 300 via a network NW. PCU 132 receives discharge power from battery 105, converts this discharge power into AC power, and supplies the converted power to motor 133, whereby motor 133 rotates and vehicle 100 travels.

HMI unit 140 is a touch screen, and receives an input of user operation and displays various screens. Accessory battery 149 stores electric power for driving auxiliaries such as HMI unit 140.

ECU 150 controls various devices of vehicle 100 such as communication unit 120, PCU 132, motor 133, and HMI unit 140. ECU 150 controls the discharge power of battery 105 under the control of PCU 132 (for example, starting and stopping).

Server 300 is operated by enterprise ENT, and includes a communication device 310, a storage device 320, and a processing device 330. Communication device 310 is communicatively connected to network NW to wirelessly communicate with an external device (for example, vehicle 100) of server 300. Communication device 310 is configured to communicate with each of vehicle inspection management server 400 and account management server 500 via network NW.

Storage device 320 stores a vehicle DB 322 and a contractor DB 326. Each data structure of vehicle DB 322 and contractor DB 326 will be described in detail layer.

Processing device 330 includes a processor and a memory (both are not shown). The processor is, for example, CPU (Central Processing Unit), and executes various calculation processing. The memory includes ROM (Read Only Memory) and RAM (Random Access Memory). The ROM stores programs to be executed by the processor.

For example, processing device 330 is configured to be capable of generating a discharge restriction command for restricting the discharge power of battery 105. This command will be described in detail later.

Vehicle inspection management server 400 is operated by an organization for managing vehicle inspections (for example, a government agency or a used car dealer), and stores a vehicle inspection information DB 450. A vehicle inspection is performed on each of a plurality of vehicles including vehicle 100.

Account management server 500 is operated by a bank, and stores an account information DB 550. Account information DB 550 includes bank account information of each of a plurality of users who use the plurality of vehicles.

Each of vehicle inspection information DB 450 and account information DB 550 is accessed by server 300 via network NW. The data structure of each of vehicle inspection information DB 450 and account information DB 550 will be described in detail later.

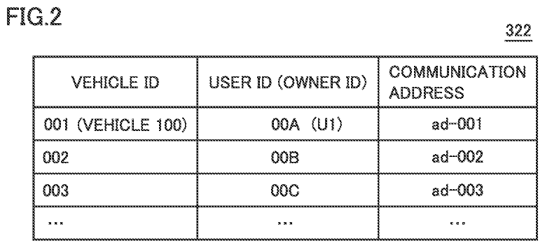

FIG. 2 is a diagram illustrating a data structure of vehicle DB 322. Referring to FIG. 2, each of a plurality of vehicles including vehicle 100 is assigned a vehicle ID. Vehicle DB 322 indicates a user ID and a vehicle communication address for each vehicle ID. This user ID indicates identification information of a vehicle user, and corresponds to the owner ID of the corresponding vehicle. The communication address is the address of the communication device of the corresponding vehicle (communication unit 120 in the example of vehicle 100). In this example, it is assumed that the vehicle having vehicle ID of 001 is vehicle 100, and the user having the user ID of 00A is user U1.

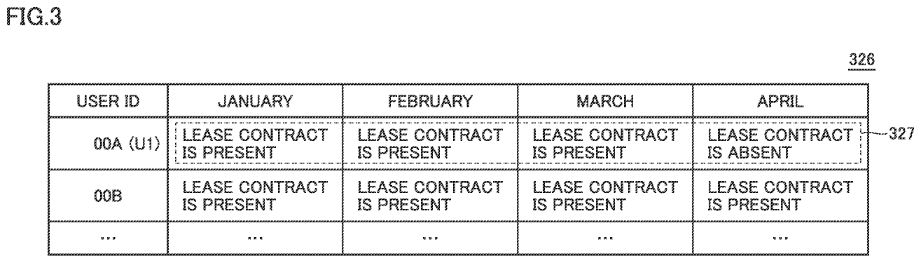

FIG. 3 is a diagram illustrating a data structure of contractor DB 326. Referring to FIG. 3, contractor DB 326 includes lease contract information 327. Lease contract information 327 indicates whether or not there is a lease contract between user U1 and enterprise ENT for every month. In this example, lease contract information 327 indicates that a lease contract had been made during the period from January to March, but no lease contract has been made in April. In other words, lease contract information 327 indicates that the lease contract has been canceled.

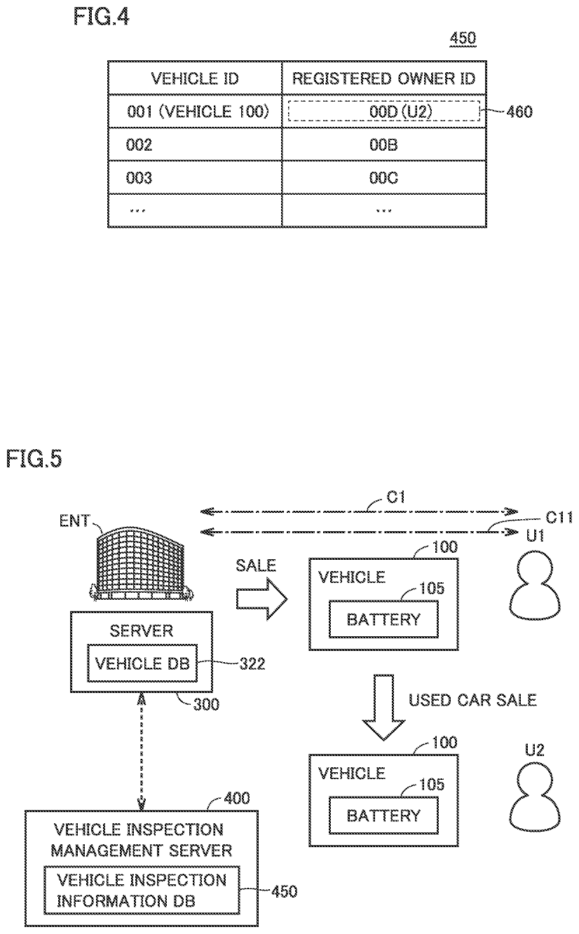

FIG. 4 is a diagram illustrating a data structure of vehicle inspection information DB 450. Referring to FIG. 4, vehicle inspection information DB 450 includes registered owner information 460. Registered owner information 460 includes registered owners ID. The registered owner is a person who is registered as the owner of a vehicle (vehicle 100 in this example) when the vehicle is inspected. In this example, it is assumed that the user having the registered owner ID of 00D is a user U2 (described later). Vehicle inspection information DB 450 may include information indicating an expiration date of vehicle inspection for each vehicle ID.

FIG. 5 is a diagram illustrating a problem caused in a case where vehicle 100 is transferred as a used car from user U1 to another person.

Referring to FIG. 5, user U1 enters into a lease contract C1 (and an insurance contract C11) with enterprise ENT and uses battery 105. Lease contract C1 and insurance contract C11 are respectively a lease contract and an insurance contract for battery 105 which are made between user U2 and enterprise ENT. Enterprise ENT manages battery 105 based on lease contract C1. Enterprise ENT can collect and reuse battery 105 after expiration of lease contract C1. Therefore, the lease contract for battery 105 such as lease contract C1 is preferable from the viewpoint of effective utilization of battery 105.

User U1 may transfer vehicle 100 (base vehicle 102 and battery 105) to user U2 as a used vehicle without permission of enterprise ENT. If vehicle 100 is transferred from user U1 to user U2, battery 105 is also transferred without permission of enterprise ENT, and the vehicle owner is changed from user U1 to user U2. On the other hand, enterprise ENT (the owner of battery 105) may not be able to grasp that battery 105 has been transferred without permission and user U2 become a new vehicle owner (an occupier of battery 105). Specifically, when the vehicle owner indicated by vehicle DB 322 is still user U1, server 300 may not be able to determine that the vehicle owner has changed. As a result, server 300 cannot determine the changed vehicle owner (user U2). Therefore, enterprise ENT cannot enter into a lease contract for battery 105 with user U2, and cannot manage battery 105 based on this lease contract. This is not preferable from the viewpoint of effective utilization of battery 105.

Server 300 according to the first embodiment has a feature for dealing with the above problem. This point will be described in detail below.

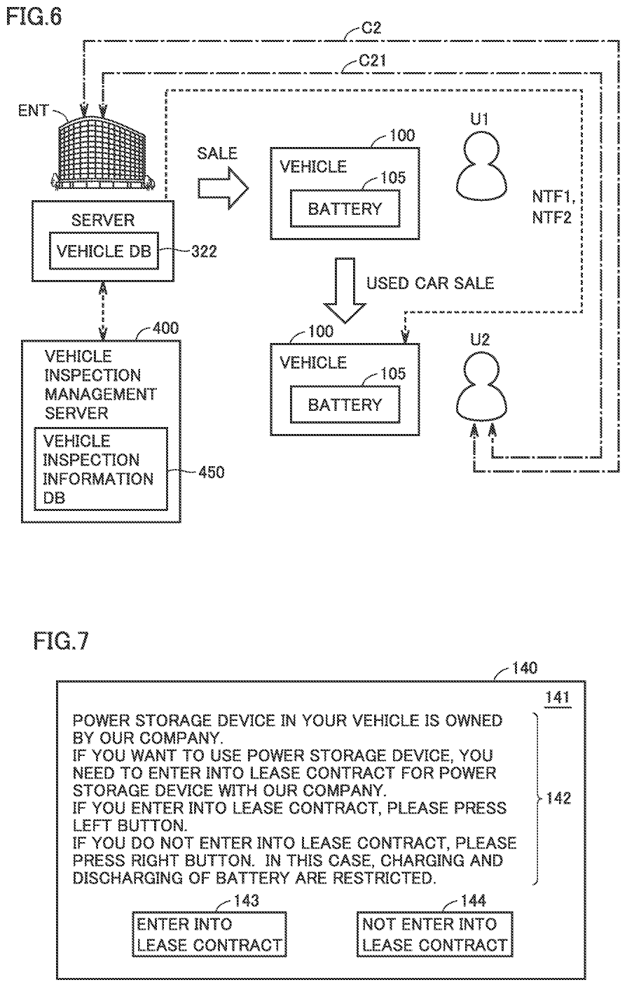

FIG. 6 is a diagram showing the feature of server 300. Referring to FIG. 6, when the vehicle owner has changed from user U1 to user U2 and user U2 does not enter into lease contract C2 with enterprise ENT, server 300 transmits the above-mentioned discharge restriction command to vehicle 100 through communication device 310. Lease contract C2 is a contract for user U2 leasing battery 105 from enterprise ENT.

With such a configuration, the discharge power of battery 105 is restricted when user U2 has not entered into lease contract C2, which causes inconvenience for user U2 due to the restriction of discharge power. As a result, user U2 can be motivated to enter into lease contract C2 in order to avoid such inconvenience. Therefore, the power storage device can be effectively used based on lease contract C2.

A discharge restriction command corresponds to a command for restricting control of PCU 132 by ECU 150. The discharge restriction command is, for example, a stop command for stopping the control of PCU 132 by ECU 150. When a restriction command (stop command) is transmitted to vehicle 100, the control of PCU 132 by ECU 150 is restricted (stopped). As a result, discharging of battery 105 is restricted (prohibited). As a result, it is possible to avoid a situation where vehicle 100 travels with the electric power of battery 105 (user U2 drives vehicle 100 illegally) even though user U2 has not entered into lease contract C2.

How server 300 determines the change of the vehicle owner will be described hereunder. Server 300 first acquires registered owner information 460 (registered owner ID) for vehicle 100 from vehicle inspection management server 400 (vehicle inspection information DB 450) through communication device 310. Then, server 300 determines according to registered owner information 460 whether or not the vehicle owner has changed from user U1. Specifically, server 300 identifies user ID (00A) related to vehicle ID (001) of vehicle 100 according to vehicle DB 322, and determines whether or not this user ID matches registered owner ID for vehicle 100. When user ID matches registered owner ID, server 300 determines that the vehicle owner is still user U1, and has not been changed. On the other hand, when these IDs are different from each other, server 300 determines that the vehicle owner has changed from user U1 to user U2 (a user identified by registered owner ID of vehicle inspection information DB 450).

Even after vehicle 100 is transferred to user U2, it is considered that a vehicle inspection of vehicle 100 is executed periodically and user U2 is identified as a registered owner at the time of the vehicle inspection. As described above, server 300 determines based on registered owner information 460 whether or not the vehicle owner has been changed. As a result, server 300 can appropriately determine (identify) the new vehicle owner (user U2).

It is preferable that server 300 acquires registered owner information 460 for vehicle 100 every predetermined period of time. Information representing the predetermined period of time is stored in storage device 320. The predetermined period of time is, for example, j days, k weeks, m months, or n years, and each of j, k, m, and n represents a natural number of 1 or more.

It is also considered that it is preferable to periodically determine whether or not the vehicle owner has changed. By acquiring registered owner information 460 every predetermined period of time as described above, server 300 can periodically determine whether or not the vehicle owner has changed.

Referring to FIG. 3 again, server 300 may determine according to lease contract information 327 whether or not the vehicle owner has changed (whether or not vehicle 100 has been transferred). When lease contract C1 is canceled, the use of vehicle 100 (base vehicle 102) by user U1 may be terminated. Therefore, server 300 may acquire registered owner information 460 when lease contract information 327 indicates that lease contract C1 has been canceled (in April and subsequent months thereto in the example of FIG. 3).

Referring to FIG. 6 again, when determining that the vehicle owner has changed from user U1 to user U2, server 300 transmits a first notification NTF1 for prompting user U2 to enter into lease contract C2 to vehicle 100. First notification NTF1 is transmitted based on the address of communication unit 120 (FIG. 2) included in vehicle DB 322.

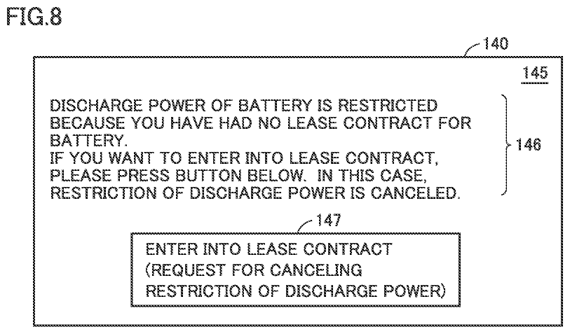

FIG. 7 is a diagram illustrating a screen displayed on HMI unit 140. This screen is displayed when vehicle 100 (communication unit 120) receives first notification NTF1.

Referring to FIG. 7, a screen 141 includes a message 142 and buttons 143 and 144. Message 142 informs user U2 that battery 105 has been owned by enterprise ENT.

Button 143 is operated when user U2 enters into lease contract C2. In response to the operation of button 143, communication unit 120 transmits a first approval signal to server 300. The first approval signal indicates that user U2 approves of entering into lease contract C2.

Button 144 is operated when user U2 does not enter into lease contract C2. In response to the operation of button 144, communication unit 120 transmits a first disapproval signal to server 300. The first disapproval signal indicates that user U2 does not enter into lease contract C2. When server 300 has received the first disapproval signal, server 300 generates a discharge restriction command and transmits it to vehicle 100.

As described above, screen 141 is displayed in response to first notification NTF1. This can effectively motivate user U2 to enter into lease contract C2.

FIG. 8 is a diagram illustrating another screen to be displayed on HMI unit 140. This screen is displayed after vehicle 100 (communication unit 120) receives a discharge restriction command.

Referring to FIG. 8, a screen 145 includes a message 146 and a button 147. Message 146 notifies user U2 that the discharge power of battery 105 is restricted. Button 147 is operated when user U2 enters into lease contract C2. In response to the operation of button 147, communication unit 120 transmits a lease contract approval signal (restriction cancel request signal) to server 300. The lease contract approval signal is similar to the first approval signal described above in that it indicates approval of user U2 to enter into lease contract C2. On the other hand, the lease contract approval signal differs from the first approval signal in that it is transmitted from vehicle 100 after the discharge power is restricted.

When server 300 has received the lease contract approval signal after receiving the first disapproval signal (that is, when button 147 is operated), server 300 transmits a restriction cancel command for cancelling the restriction on discharge power to vehicle 100 through communication device 310. Therefore, when user U2 enters into lease contract C2 after the restriction of the discharge power, the restriction of discharge power is canceled. This solves the inconvenience for user U2 due to the restriction of discharge power. As a result, user U2 can be effectively motivated to enter into lease contract C2.

Referring again to FIG. 6, server 300 may transmit, to vehicle 100, a second notification NTF2 for prompting user U2 to enter into an insurance contract C21. Second notification NTF2 is transmitted based on the address of communication unit 120 which is included in vehicle DB 322. Insurance contract C21 is a contract for reducing a repair cost required to repair a damage when battery 105 suffers the damage while vehicle 100 is being used by user U2.

According to second notification NTF2, it is possible to motivate user U2 to enter into insurance contract C21 in addition to lease contract C2. As a result, in the case where battery 105 is damaged, user U2 only has to pay a reduced repair cost. Therefore, it is possible to avoid a situation in which user U2 loses the motivation to use vehicle 100 due to damage to battery 105. Therefore, it is possible to avoid a situation in which base vehicle 102 is not effectively used by user U2 after battery 105 fails. A specific procedure of executing processing involving second notification NTF2 will be described in a second modification.

User U2 can use HMI unit 140 to determine whether or not insurance contract C21 should be approved. This point will be described below. In response to reception of second notification NTF2, HMI unit 140 displays an inquiry screen (not shown) for inquiring of user U2 about whether or not insurance contract C21 should be approved. User U2 operates this screen to determine whether or not to approve insurance contract C21. When user U2 uses HMI unit 140 to perform an operation of approving insurance contract C21, communication unit 120 transmits a second approval signal to server 300. The second approval signal indicates that user U2 approves of entering insurance contract C21. When user U2 does not perform the operation of approving insurance contract C21, communication unit 120 transmits a second disapproval signal to server 300. The second disapproval signal indicates that user U2 does not enter into insurance contract C21.

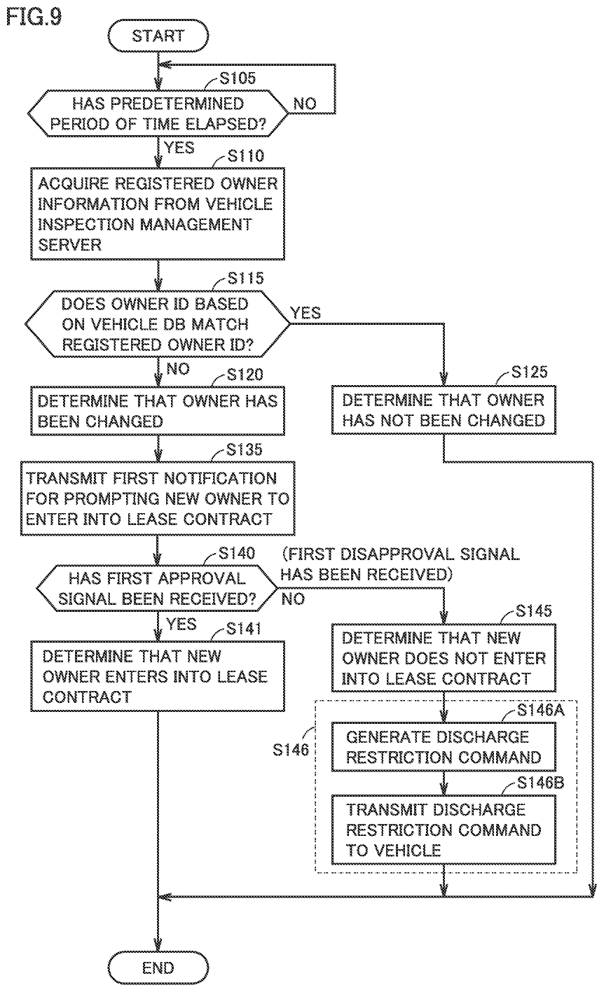

FIG. 9 is a flowchart illustrating the processing to be executed by server 300 according to the first embodiment. Hereinafter, the step is abbreviated as “S”.

Referring to FIG. 9, server 300 determines whether or not the aforementioned predetermined period of time has elapsed since registered owner information 460 was previously acquired (S105). If the predetermined period of time has not yet elapsed (NO in S105), S105 is repeated until the predetermined period of time has elapsed. If the predetermined period of time has elapsed (YES in S105), the processing proceeds to S110.

Server 300 acquires registered owner information 460 from vehicle inspection management server 400 (vehicle inspection information DB 450) (S110). Server 300 determines whether or not the owner ID (ID of user U1) for vehicle 100 based on vehicle DB 322 matches the registered owner ID of registered owner information 460 (S115). If the owner ID matches the registered owner ID (YES in S115), server 300 determines that the vehicle owner has not been changed from user U1 (S125), and ends the processing. If the owner ID does not match the registered owner ID, that is, if the owner ID is different from the registered owner ID (NO in S115), server 300 determines that the vehicle owner has been changed from user U1 (S120). Then, server 300 determines (identifies) a new owner (user U2) based on the registered owner ID. Then, the processing proceeds to S135.

Server 300 transmits first notification NTF1 for prompting user U2 to enter into the lease contract C2 (S135) to vehicle 100 through communication device 310. Thereafter, the processing proceeds to S140.

Server 300 determines whether or not it has received the above-mentioned first approval signal from vehicle 100 within a predetermined first approval period of time (S140). Information representing the first approval period of time is stored in storage device 320. The first approval period of time is a period of time after first notification NTF1 (S135), and it is, for example, a period of time within i1 days from the time of transmission of first notification NTF1 (i1 represents a natural number).

If server 300 has received the first approval signal within the first approval period (YES in S140), server 300 determines that user U2 enters into lease contract C2 (S141). In this case, the processing ends.

If server 300 has not received the first approval signal within the first approval period of time, in this example, if server 300 has received the first disapproval signal through communication device 310 (NO in S140), server 300 determines that user U2 does not enter into lease contract C2 (S145). Next, server 300 generates a discharge restriction command (S146A) and transmits the discharge restriction command to vehicle 100 (S146B). The processing consisting of S146A and S146B is also referred to as discharge restriction processing (S146). After the discharge restriction processing, the processing ends.

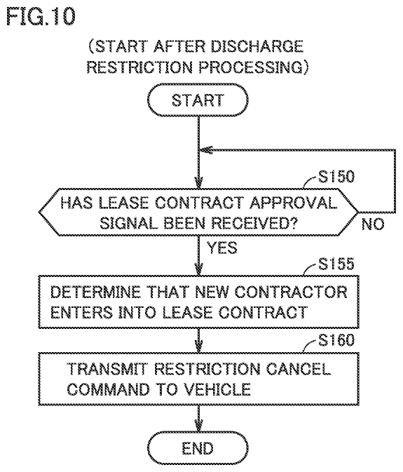

FIG. 10 is a flowchart illustrating another processing to be executed by server 300 according to the first embodiment. This flowchart is started after the discharge restriction processing.

Referring to FIG. 10, server 300 determines whether or not it has received the aforementioned lease contract approval signal (S150). If server 300 has not yet received the lease contract approval signal (NO in S150), server 300 repeats S150 until it receives this signal. If server 300 has received the lease contract approval signal (YES in S150), server 300 determines that user U2 enters into lease contract C2 (S155). Based on the result of this determination, server 300 transmits a restriction cancel command to vehicle 100 (S160). Thereafter, the processing ends.

According to the first embodiment, user U2 can be motivated to enter into lease contract C2 in order to avoid the inconvenience caused by the restriction of discharge power. As a result, battery 105 can be effectively used based on lease contract C2.

### [First Modification]

Server 300 may acquire registered owner information 460 when a situation where the lease fee of battery 105 has not been paid continues over a predetermined threshold period of time. This lease fee is set by lease contract C1 as a fee which user U1 must pay to lease battery 105. Information representing the threshold period of time is stored in storage device 320. The threshold period of time is, for example, e days, f weeks, g months, or h years, and each of e, f, g, and h represents a natural number of 1 or more.

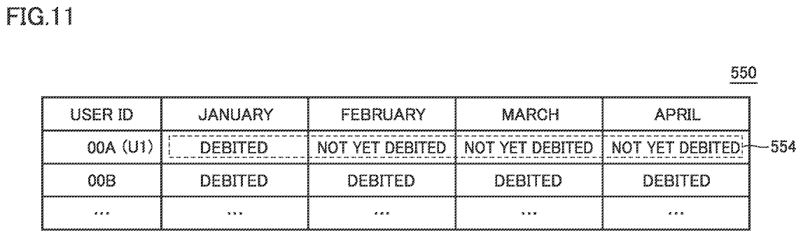

FIG. 11 is a diagram illustrating a data structure of account information DB 550. As mentioned above, account information DB 550 is stored in account management server 500.

Referring to FIG. 11, account information DB 550 includes payment status information 554. Payment status information 554 indicates monthly the payment status of the lease fee by user U1 (specifically, whether the lease fee has been debited or not). In this example, a threshold period of time is assumed to be three months. Payment status information 554 indicates non-payment of the lease fee by user U1 over the threshold period of time (three months from February to April).

Server 300 acquires payment status information 554 from account management server 500 (account information DB 550) through communication device 310. In this example, server 300 determines that payment status information 554 indicates non-payment of the lease fee over the threshold period of time. Server 300 acquires registered owner information 460 based on this determination result.

When non-payment of the lease fee continues over a period of time longer than the threshold period of time, user U1 may have already disappeared after illegally transferring vehicle 100 (base vehicle 102 and battery 105) to user U2. In this first modification, non-payment of the lease fee by user U1 acts as a trigger for causing server 300 to acquire registered owner information 460. As a result, server 300 can determine the new vehicle owner (user U2) based on registered owner information 460. Therefore, server 300 can determine, at an appropriate timing, that the vehicle owner has changed from user U1 to user U2.

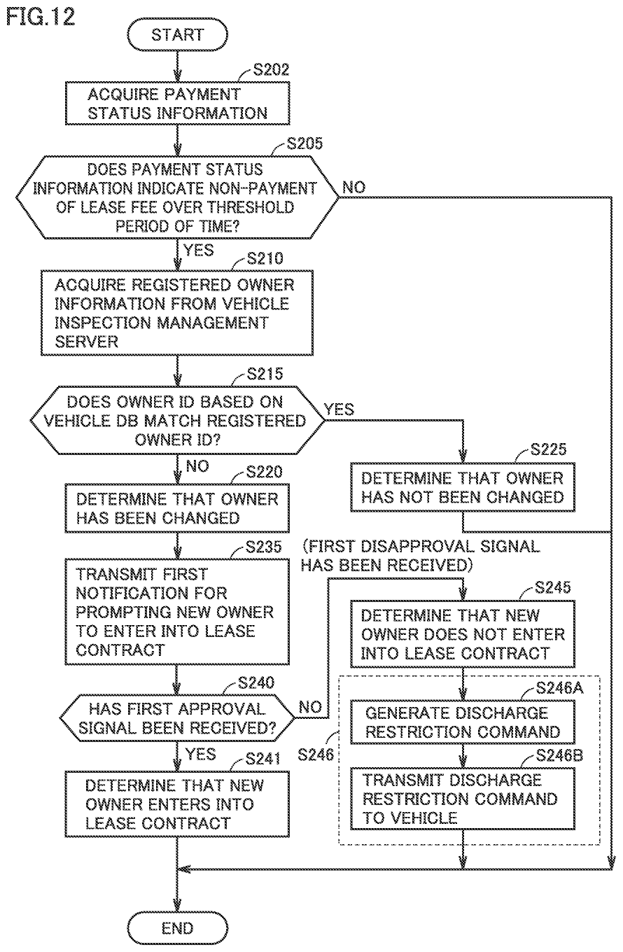

FIG. 12 is a flowchart illustrating processing to be executed by server 300 according to the first modification. Referring to FIG. 12, this flowchart differs from the flowchart of the first embodiment (FIG. 9) in that S202 is added and S205 is executed instead of S105. S210 to S246 are similar to S110 to S146, respectively. This flowchart is executed, for example, every predetermined period of time described above.

Server 300 acquires payment status information 554 from account management server 500 (account information DB 550) through communication device 310 (S202). Server 300 determines whether or not payment status information 554 indicates non-payment of the lease fee over the threshold period of time (S205). If payment status information 554 indicates non-payment of the lease fee over the threshold period of time (YES in S205), the processing proceeds to S210. If not (NO in S205), the processing ends.

According to the first modification, server 300 can determine, at an appropriate timing, that the vehicle owner has changed from user U1 to user U2. As a result, the number of times at which server 300 accesses vehicle inspection management server 400 to acquire registered owner information 460 can be reduced to the necessity minimum.

### [Second Modification]

In this second modification, it is assumed that user U2 has had lease contract C2. In this case, server 300 executes upper limit setting processing for setting an upper limit value for the discharge power of battery 105.

Server 300 executes the upper limit setting processing according to the presence or absence of insurance contract C21. The upper limit setting processing includes first setting processing for setting the upper limit value to V1, and second setting processing for setting the upper limit value to V2 (>V1). For example, when user U2 enters into lease contract C2, but user U2 does not enter into insurance contract C21, server 300 executes the first setting processing. When user U2 enters into lease contract C2 and user U2 enters into insurance contract C21, server 300 executes the second setting processing.

Server 300 transmits the upper limit value (V1 or V2) set by the upper limit setting processing to vehicle 100. After receiving this upper limit value, ECU 150 controls PCU 132 so that the value of the discharge power of battery 105 does not exceed the upper limit value.

When the upper limit value is set to a low value, there is a possibility that battery 105 is not sufficiently discharged, which impairs the convenience for user U2 (for example, the traveling speed of vehicle 100 may be limited). With the above configuration, when user U2 enters into both lease contract C2 and insurance contract C21, the upper limit value is set to a higher value than that in a case where user U2 enters into only lease contract C2 and does not enter into insurance contract C21, which allows battery 105 to be sufficiently discharged and makes it possible to enhance the convenience for user U2 (for example, user U2 can drive vehicle 100 without any restriction on travel speed). As a result, user U2 can be motivated to enter into insurance contract C21 in addition to lease contract C2.

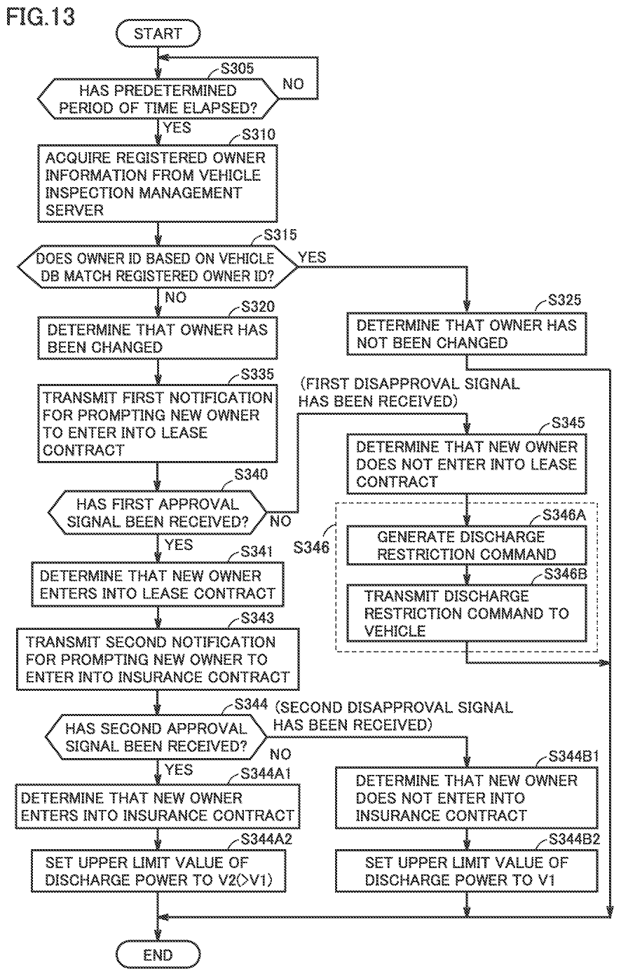

FIG. 13 is a flowchart illustrating processing to be executed by server 300 according to the second modification. Referring to FIG. 13, this flowchart differs from the flowchart of the first embodiment (FIG. 9) in that S343, S344, S344A1, S344A2, S344B1, and S344B2 are added. S305 to S341, S345, and S346 are the same as S105 to S141, S145, and S146, respectively.

When server 300 determines that user U2 enters into lease contract C2 (after S341), server 300 transmits second notification NTF2 for prompting user U2 to enter into insurance contract C21 to vehicle 100 through communication device 310 (S343). Thereafter, the processing proceeds to S344.

Server 300 determines whether or not it has received the second approval signal described above from vehicle 100 through communication device 310 within the second approval period (S344). Information representing the second approval period is stored in storage device 320. The second approval period is a period after second notification NTF2 (S343), and it is, for example, a period within i2 days from the transmission time of second notification NTF2 (i2 represents a natural number).

When receiving the second approval signal within the second approval period (YES in S344), server 300 determines that user U2 enters into insurance contract C21 (S344A1). Then, server 300 sets the upper limit value of discharge power to V2 (>V1) (S344A2). Server 300 transmits V2 to vehicle 100 through communication device 310, and ends the processing.

If server 300 has not received the second approval signal within the second approval period, for example, if it has received the second disapproval signal (NO in S344), server 300 determines that user U2 does not enter into insurance contract C21 (S344B1). Then, server 300 sets the upper limit of discharge power to V1 (S344B2). Server 300 transmits V1 to vehicle 100 through communication device 310, and ends the processing.

According to the second modification, user U2 can be motivated to enter into insurance contract C21 in addition to lease contract C2. As a result, it is possible to avoid a situation where vehicle 100 (base vehicle 102) is not effectively used by user U2 after failure of battery 105.

### [Third Modification]

In a third modification, when receiving a transfer notification indicating that user U1 transfers vehicle 100, server 300 executes incentive providing processing. The incentive providing processing corresponds to processing for providing incentive to user U1. The incentive is, for example, the discount on the aforementioned lease fee, but it may also be points usable at various stores or electronic money.

User U1 uses HMI unit 140 to perform a user operation (transfer notification operation) of notifying enterprise ENT that user U1 himself/herself transfers vehicle 100. Communication unit 120 transmits a transfer notification to server 300 in response to this user operation. After vehicle 100 is transferred, it is considered that it is highly likely that user U1 will no longer use vehicle 100. Therefore, it is considered that it is highly likely that lease contract C1 will be canceled after transmission of the transfer notification.

According to the incentive providing processing in the third modification, user U1 can be motivated to notify enterprise ENT of the transfer of vehicle 100, which enables server 300 to easily determine the transfer of vehicle 100. For example, server 300 can identify a transferee (user U2) of vehicle 100 by acquiring registered owner information 460 at an appropriate timing after receiving the transfer notification. As a result, user U2 can be easily prompted to enter into lease contract C2 through first notification NTF1. An example of the above appropriate timing is immediately after the expiration date of a vehicle inspection of vehicle 100.

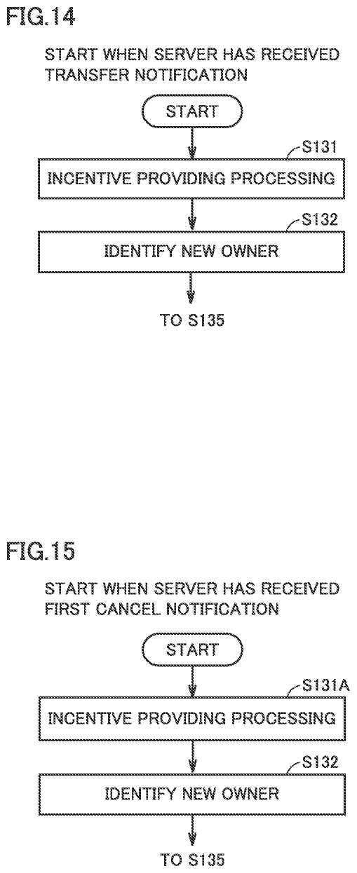

FIG. 14 is a flowchart illustrating processing to be executed by server 300 according to the third modification. This flowchart starts upon reception of the transfer notification by server 300.

Referring to FIG. 14, server 300 executes the incentive providing processing in response to reception of the transfer notification (S131). Thereafter, server 300 identifies user U2 by acquiring registered owner information 460 (S132). After S132, the processing proceeds to S135 (FIG. 9).

According to the third modification, it is possible to easily prompt user U2 to enter into lease contract C2.

The transfer notification may include transferee information indicating user U2 (transferee). In this case, after S131, server 300 identifies user U2 based on the transferee information (S132). Thereafter, on the condition that lease contract information 327 indicates the continuation of lease contract C1 (in other words, lease contract C1 is not canceled), server 300 is not required to execute the processing of S135 onwards. As a result, when user U2 is a family member of user U1, it is possible to avoid a situation where the inconvenience for user U2 is caused by the restriction of discharge power.

### [Fourth Modification]

In a fourth modification, server 300 executes the incentive providing processing when it has received a first cancel notification indicating that user U1 cancels lease contract C1. User U1 uses HMI unit 140 to perform a user operation (lease contract cancel notification operation) for notifying the cancellation of lease contract C1 by himself/herself. Communication unit 120 transmits the first cancel notification to server 300 in response to this user operation.

According to the incentive providing processing in the fourth modification, user U1 can be motivated to notify enterprise ENT of the cancellation of lease contract C1. As a result, server 300 can easily determine cancellation of lease contract C1. When lease contract C1 is canceled, the use of vehicle 100 (base vehicle 102) by user U1 may be ended. Therefore, server 300 can identify the transferee (user U2) of vehicle 100 by acquiring registered owner information 460 at an appropriate timing after receiving the first cancel notification. As a result, it is possible to easily prompt user U2 to enter into lease contract C2 through first notification NTF1.

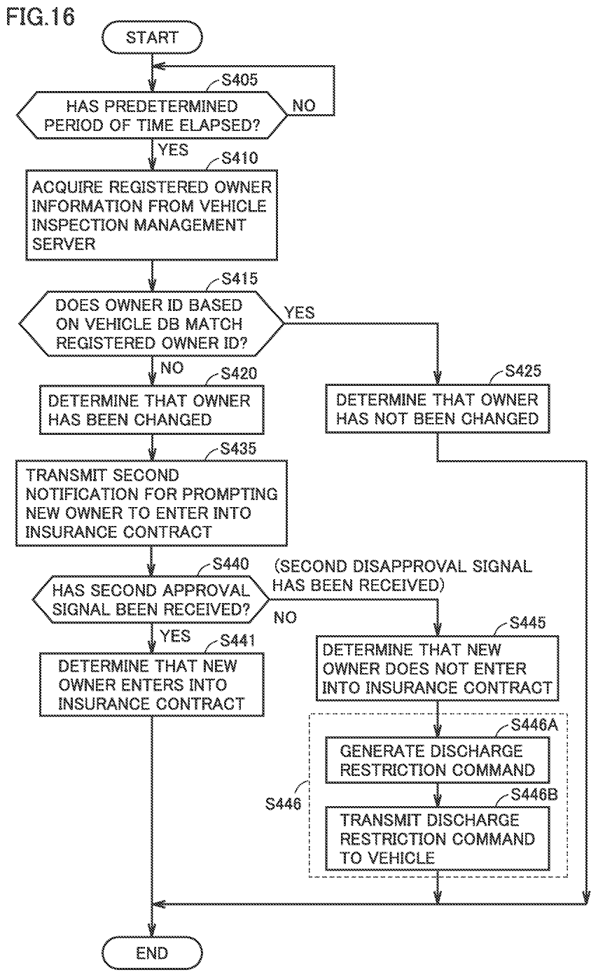

FIG. 15 is a flowchart illustrating processing to be executed by server 300 according to the fourth modification. This flowchart starts when server 300 has received the first cancel notification.

Referring to FIG. 15, this flowchart differs from the flowchart of the third modification (FIG. 14) in that S131A is executed instead of S131. The processing of S132 onwards is the same as the processing in FIG. 14.

Server 300 executes the incentive providing processing in response to the reception of the first cancel notification (S131A). Thereafter, the processing proceeds to S132.

According to the fourth modification, similarly to the third modification, it is possible to easily prompt user U2 to enter into lease contract C2.

### [Fifth Modification]

When server 300 determines that the vehicle owner has changed, server 300 may execute the discharge restriction processing before receiving the first approval signal. For example, server 300 may execute the discharge restriction processing (S146) after S120 in FIG. 9 and before YES in S140.

With the above processing, discharging of battery 105 is immediately restricted after it is determined that the vehicle owner has changed. As a result, it is possible to prevent user U2 from illegally using battery 105 (illegally driving vehicle 100) without entering into lease contract C2 before receiving the first approval signal. Note that even when discharging of battery 105 is immediately restricted before receiving the first approval signal as described above, HMI unit 140 displays screen 141 using the electric power of auxiliary battery 149.

### Second Embodiment

In a second embodiment, when server 300 determines that the vehicle owner has changed from user U1 to user U2 and user U2 does not enter into insurance contract C21, server 300 transmits a discharge restriction command to vehicle 100 through communication device 310. In other words, whether or not the discharge restriction processing is executed depends on the presence or absence of insurance contract C21, and is unrelated to the presence or absence of lease contract C2.

With such a configuration, discharge power is restricted when user U2 does not have insurance contract C21. Therefore, user U2 can be motivated to enter into insurance contract C21 in order to avoid the inconvenience caused by the restriction of discharge power.

The configuration of information processing system 10 in the second embodiment is basically the same as that in the first embodiment.

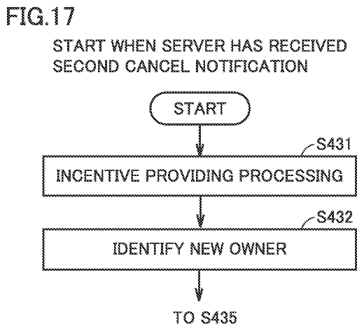

FIG. 16 is a flowchart illustrating processing to be executed by server 300 according to the second embodiment. Referring to FIG. 16, this flowchart differs from the flowchart of the first embodiment (FIG. 9) in that S435 to S445 are executed instead of S135 to S145, respectively. S405 to S425 and S446 are similar to S105 to S125 and S146, respectively.

When server 300 determines that the vehicle owner has changed (after S420), server 300 transmits second notification NTF2 for prompting user U2 to enter into insurance contract C21 to vehicle 100 through communication device 310 (S435). Thereafter, the processing proceeds to S440.

Server 300 determines whether or not it has received the above-described second approval signal from vehicle 100 within the second approval period (S440). If server 300 has received the second approval signal within the second approval period (YES in S440), server 300 determines that user U2 enters into insurance contract C21 (S441). In this case, the processing ends. If server 300 has not received the second approval signal within the second approval period, in this example, if server 300 has received the second disapproval signal through communication device 310 (NO in S440), server 300 determines that user U2 does not enter into insurance contract C21 (S445), and executes the discharge restriction processing (S446). Thereafter, the processing ends.

According to the embodiment, user U2 can be motivated to enter into insurance contract C21 in order to avoid inconveniences caused by the restriction of discharge power. As a result, it is possible to avoid a situation where vehicle 100 is not effectively used by user U2 after battery 105 fails.

### [Modification of Second Embodiment]

As mentioned above, it is assumed that user U1 has continued insurance contract C11 since user U1 purchased vehicle 100. If such insurance contract C11 is canceled, use of vehicle 100 (base vehicle 102) by user U1 may be terminated.

When receiving a second cancel notification indicating that user U1 cancels insurance contract C11, server 300 according to this modification executes the incentive providing processing. User U1 uses HMI unit 140 at the time of transferring vehicle 100 to perform a user operation (insurance contract cancel notification operation) for notifying cancellation of insurance contract C11 by himself/herself. Communication unit 120 transmits the second cancel notification to server 300 in response to this user operation.

According to the incentive providing processing in this modification, it is possible to motivate user U1 to notify enterprise ENT of the cancellation of insurance contract C11, so that server 300 can easily determine the cancellation of insurance contract C11. As described above, when insurance contract C11 is canceled, the use of vehicle 100 (base vehicle 102) by user U1 may be terminated. Therefore, server 300 can identify the transferee (user U2) of vehicle 100 by acquiring registered owner information 460 at an appropriate timing after receiving the second cancel notification. As a result, it is possible to easily prompt user U2 to enter into insurance contract C21 through second notification NTF2.

FIG. 17 is a flowchart illustrating processing to be executed by server 300 according to this modification. This flowchart starts when server 300 has received the second cancel notification.

Referring to FIG. 17, server 300 executes the incentive providing processing in response to reception of the second cancel notification (S431). Thereafter, server 300 identifies user U2 by acquiring registered owner information 460 (S432). After S432, the processing proceeds to S435 (FIG. 16).

According to this modification, it is possible to easily prompt user U2 to enter into insurance contract C21.

Although the embodiments of the present disclosure have been described, the embodiments disclosed at this time should be considered to be illustrative in all respects and not restrictive. The scope of the present disclosure is indicated by the claims, and it is intended that all changes within the meaning equivalent to the claims and the range thereof are included.

What is claimed is:

1. A server that communicates with a vehicle including a power storage device, the server comprising:
a communication device that communicates with the vehicle; and
a processing device that generates a restriction command for restricting discharge power of the power storage device, wherein
a first owner as an owner of the vehicle has entered into a first lease contract for leasing the power storage device, and
the processing device transmits the restriction command to the vehicle through the communication device when the owner has been changed from the first owner to a second owner and the second owner does not enter into a second lease contract for leasing the power storage device.

2. The server according to claim 1, wherein
the communication device is configured to communicate with a first management server that stores registered owner information indicating a registered owner who is registered as an owner of the vehicle when a vehicle inspection of the vehicle is performed, and
the processing device
acquires the registered owner information from the first management server through the communication device, and
determines according to the registered owner information whether or not the owner has been changed.

3. The server according to claim 2, wherein
the communication device is configured to communicate with a second management server,
the second management server stores payment status information indicating a payment status of a lease fee for the power storage device,
the lease fee is set by the first lease contract as a fee that the first owner is required to pay for leasing the power storage device, and
the processing device
acquires the payment status information from the second management server through the communication device, and
acquires the registered owner information when the payment status information indicates non-payment of the lease fee over a predetermined threshold period of time.

4. The server according to claim 2, wherein the processing device acquires the registered owner information every predetermined period of time.

5. The server according to claim 1, wherein when determining that the owner has been changed to the second owner, the processing device transmits a first notification for prompting the second owner to enter into the second lease contract to the vehicle through the communication device.

6. The server according to claim 1, wherein the processing device determines that the second owner does not enter into the second lease contract when receiving, through the communication device, a first disapproval signal indicating that the second owner does not enter into the second lease contract.

7. The server according to claim 6, wherein the processing device transmits a cancel command for canceling a restriction of the discharge power to the vehicle through the communication device when the processing device receives, after receiving the first disapproval signal, a lease contract approval signal approving that the second owner enters into the second lease contract.

8. The server according to claim 1, wherein when determining that the second owner enters into the second lease contract, the processing device transmits, to the vehicle through the communication device, a second notification for prompting the second owner to enter into an insurance contract for the power storage device.

9. The server according to claim 1, wherein
the processing device is configured to be capable of executing upper limit setting processing for setting an upper limit value of the discharge power, and
the upper limit setting processing includes
first setting processing for setting the upper limit value to a first value when the second owner enters into the second lease contract and the second owner does not enter into an insurance contract for the power storage device, and
second setting processing for setting the upper limit value to a second value higher than the first value when the second owner enters into the second lease contract and the second owner enters into the insurance contract.

10. The server according to claim 9, wherein the processing device determines that the second owner does not enter into the insurance contract when receiving, through the communication device, a second disapproval signal indicating that the second owner does not enter into the insurance contract.

11. The server according to claim 1, wherein the processing device executes processing for providing an incentive to the first owner when receiving a transfer notification indicating that the first owner transfers the vehicle.

12. The server according to claim 1, wherein the processing device executes processing for providing an incentive to the first owner when receiving a first cancel notification indicating that the first owner cancels the first lease contract.

13. A server that communicates with a vehicle including a power storage device, the server comprising:
a communication device that communicates with the vehicle; and
a processing device that generates a restriction command for restricting discharge power of the power storage device, wherein
a first owner as an owner of the vehicle has entered into a first insurance contract for the power storage device, and
the processing device transmits the restriction command to the vehicle through the communication device when the owner has been changed from the first owner to a second owner and the second owner does not enter into a second insurance contract for the power storage device.

14. The server according to claim 13, wherein the processing device executes processing for providing an incentive to the first owner when receiving a second cancel notification indicating that the first owner cancels the first insurance contract.
